(19) United States
(12) Patent Application Publication
(10) Pub. No.: US 2013/0103549 A1
(43) Pub. Date: Apr. 25, 2013

(54) INTERACTIVE HVAC SALES SYSTEMS

(71) Applicant: Trane International, Inc., Piscataway, NJ (US)

(72) Inventors: Ryan Hilliard, Whitehouse, TX (US); Brian Purcell, Carrolton, TX (US); Adam Jones, Charlotte, NC (US); Bruce Tansy, Greenfield, IN (US); Ali Isham, Whitehouse, TX (US); Paul Adair, Pittsburgh, PA (US); Kirk Spencer, Carmel, IN (US)

(73) Assignee: TRANE INTERNATIONAL, INC., Piscataway, NJ (US)

(21) Appl. No.: 13/657,398

(22) Filed: Oct. 22, 2012

Related U.S. Application Data
(60) Provisional application No. 61/549,729, filed on Oct. 20, 2011.

(51) Int. Cl. G06Q 30/00

(52) U.S. Cl. CPC G06Q 30/0641
USPC 705/26.61

(57) ABSTRACT

An interactive HVAC sales system is disclosed. The system includes a database storing manufacturer information and distributor/dealer information for a plurality of HVAC components and a server in communication with the database, a manufacturer computer, a distributor/dealer computer, and a sales representative computer via one or more networks. The system is operable to process input of subjective customer preference information and objective building information to identify a subset of a plurality of HVAC components conforming to the objective and the subjective information. The system is further operable to identify one or more saleable combinations of the subset of HVAC components meeting predetermined system certification standards and output information for each of the saleable combinations to a mobile computing device or sales representative computer.

### CROSS-REFERENCE

The present application claims the benefit of U.S. Provisional Patent Application No. 61/549,729 filed on Oct. 20, 2011, which is hereby incorporated by reference in its entirety.

### BACKGROUND

A variety of internet-based sales systems have been used to provide virtual marketplaces such as a number of well known e-commerce sites and internet airline ticket search sites. While successful, existing approaches suffer from shortcomings and failures where there is a need to integrate input and output from a plurality of classes of users, such as manufacturers, distributors, dealers, and sales representatives. This need is particularly felt, though not limited to, products such as HVAC systems which must be customized to some degree to deliver optimal performance, and for which the customization involves component compatibility and certification standard compliance issues. It would be desirable to provide a system that allowed determination of correctly configured saleable product options, comparison of a plurality the correctly configured saleable product options, as well as providing coordination, scheduling and updating of information including product price, warranty terms, sales contract terms, product availability, inventory, and delivery information. Existing approaches suffer from various shortcomings relative to these and other needs. There remains a need for further contributions in this area of technology.

### SUMMARY

One embodiment of the present application is an interactive HVAC sales system including a database storing manufacturer information and distributor/dealer information for a plurality of HVAC components and a server in communication with the database, a manufacturer computer, a distributor/dealer computer, and a sales representative computer via one or more networks. In certain forms, the system is operable to process input of subjective customer preference information and objective building information to identify a subset of a plurality of HVAC components conforming to the objective and the subjective information. In certain forms. the system is further operable to identify one or more saleable combinations of the subset of HVAC components meeting predetermined system certification standards and output information for each of the saleable combinations to a mobile computing device or sales representative computer. Other embodiments include apparatuses, systems, devices, hardware, methods, and combinations for a system utilizing information. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic block diagram of a system.

FIG. 2 is a schematic block diagram of a computer.

FIG. 2A is a schematic block diagram of a processing subsystem.

FIG. 2B is a schematic block diagram of a processing subsystem.

FIG. 3 is a schematic block diagram of a system.

FIG. 4 is a schematic flow diagram of a technique for establishing and/or updating pricing information.

FIG. 5 is a diagram of a mobile computing device for recommending a product.

FIG. 6 is a diagram of mobile computing device for generating and/or presenting one or more proposal documents.

FIG. 7 is an exemplary screenshot of a mobile computing device with several modules.

FIG. 7A is an exemplary screenshot of a mobile computing device with several modules.

FIG. 8 is an exemplary screenshot of a mobile computing device with a client information module.

FIG. 9 is an exemplary screenshot of a mobile computing device with a customer preferences module.

FIG. 10 is an exemplary screenshot of a mobile computing device with a home survey module.

FIG. 10A is an exemplary screenshot of a mobile computing device with a load calculation module.

FIG. 11 is an exemplary screenshot of a mobile computing device with a equipment selection module.

FIG. 12 is an exemplary screenshot of a mobile computing device with a presentation module.

FIG. 13 is an exemplary screenshot of a mobile computing device with a presentation module.

FIG. 13A is an exemplary screenshot of a mobile computing device with a presentation module.

FIG. 14 is an exemplary screenshot of a mobile computing device with a presentation module.

FIG. 14A is an exemplary screenshot of a mobile computing device with a presentation module.

FIG. 15 is an exemplary screenshot of a mobile computing device with a presentation module.

FIG. 16 is an exemplary screenshot of a mobile computing device with a presentation module.

FIG. 16A is an exemplary screenshot of a mobile computing device with a presentation module.

FIG. 16B is an exemplary screenshot of a mobile computing device with a presentation module.

FIG. 16C is an exemplary screenshot of a mobile computing device with a presentation module.

FIG. 17 is an exemplary screenshot of a mobile computing device with a proposal module.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In one aspect, the present application relates to a method for providing data for a sales application where the manufacturer, distributor, and/or dealer can create and modify data on a server that can then be published for the application, while preserving a history of changes. Data may be updated from the manufacturer and a notification may go out to channel partners. The information is stored at the server and the channel partner can layer on additional data or modify the data and publish the information to the dealership. The dealer can then likewise view the data that is stored and layer modified data that will then be published to the sales professional for presentation.

Another aspect of the present application relates to a method for making a recommendation for equipment for a specific application based on information collected at the application location. By providing information such as size requirements, and/or the efficiency rating, the present application can match equipment based on certified standards. This verification process can also be used to enable customers to apply for incentives.

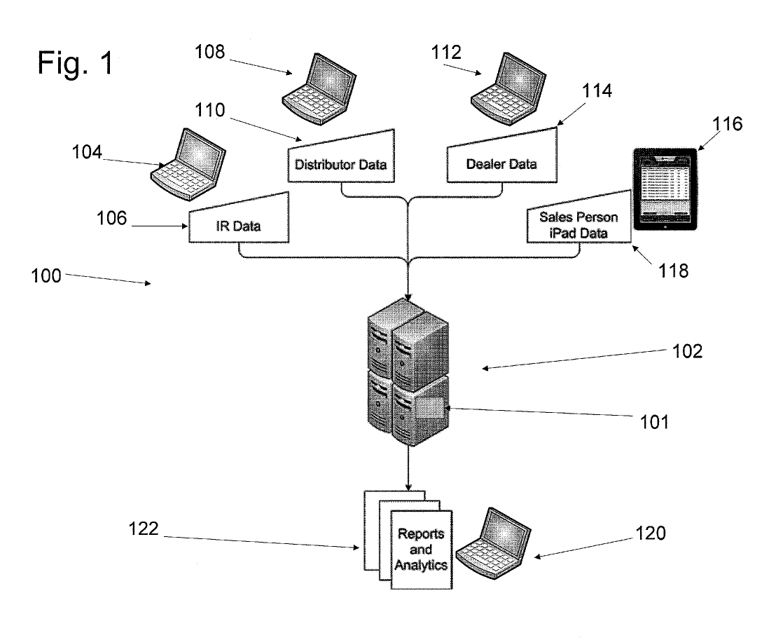

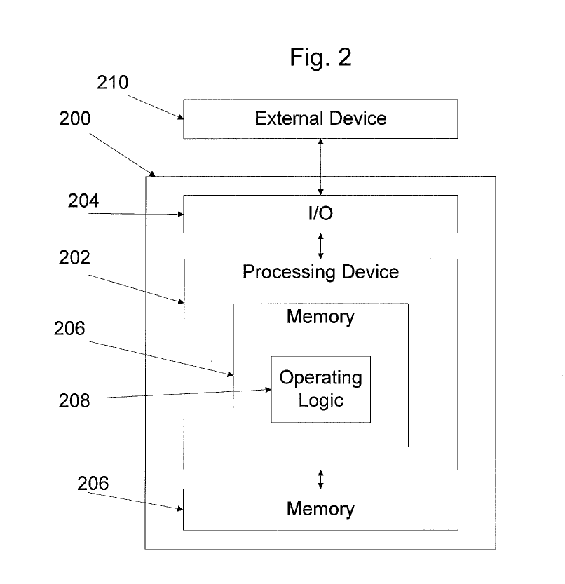

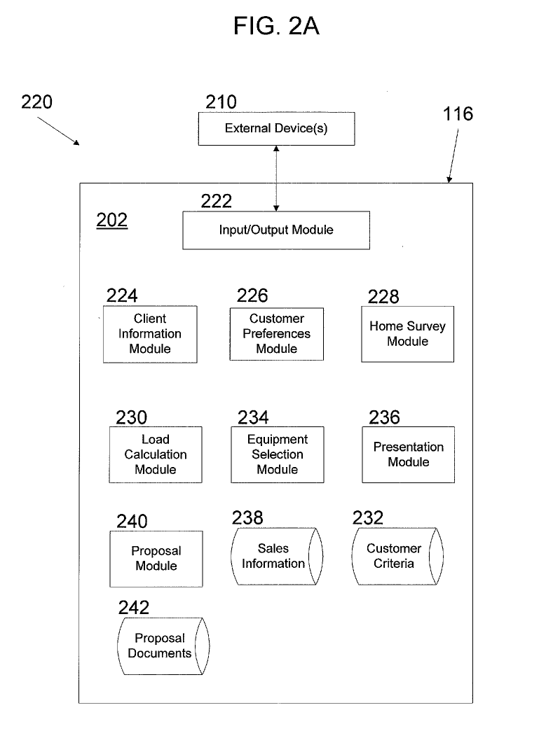

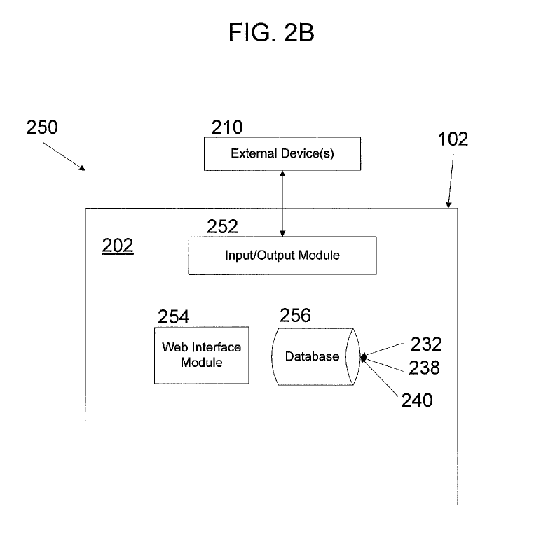

FIG. 1 is a schematic diagram of a system 100 for collecting and managing product sales information and data 101 in a storage system 102. The storage system 102 may include a server and a database as seen in FIG. 2B. Various classes of users (such as, manufacturers, distributors, dealers, sales representatives, and/or customers) may add or modify information or data at the storage system 102. A manufacturer may use a computer 104 to provide information 106 relating to various products, for example, heating, ventilation, and air conditioning (HVAC) devices and systems. A distributor may use a computer 108 to provide information 110 to the storage system relating to the products. A dealer may use a computer 112 to provide information 114 relating to the products.

A sales person may use a computer 116, for example, a tablet computer, smartphone, netbook, laptop or other portable computing device to provide sales information 118 to the storage system.

The information 106 that a manufacturer may provide includes a history of the manufacturer, pricing information for each product, specifications for each product that describe the product features such as performance and efficiency specifications, videos and photos of the product(s), explanations of the technologies used in the product(s), awards won by the manufacturer, results of customer satisfaction surveys, customer testimonials about the manufacturer, product inventory, delivery/manufacturing time for a particular product, a template contract, and a warranty information.

The information 110 that a distributor may provide includes a history of the distributor, customer testimonials about the distributor, awards won by the distributor, results of customer satisfaction surveys, product inventory, orders, and pricing information based on the manufacturer's pricing.

The information 114 that a dealer may provide includes a history of the dealer, pricing information based on the manufacturer's and/or the distributor's pricing information, customer lists, customer feedback about the products and/or services, customer preferences, home survey specifications, competitive intelligence, orders, customer testimonials about the dealer, awards won by the dealer, results of customer satisfaction surveys, product inventory, a proposal to a customer, a work order, a contract, a warrantee/product registration, an invoice, and a credit application.

The information 118 that a sales person may provide includes information about the sales person's background and experience, customer testimonials about the sales person, and awards won by the sales person.

The computers 104, 108, 112 and 116 may also receive the information 101 from the storage system 102. The information 101 provided to the various computers may be tailored to each recipient. For example, the manufacturer computer 104 may receive information about the number of ordered products or potential customers which has been provided by the distributor, the dealer and/or the sales person. The manufacturer computer 104 may also receive information about inventory of the distributor and/or dealer, customer feedback, competitive intelligence, customer lists, customer preferences, home survey specifications, work orders, contracts, warrantee/product registrations, invoices, and credit applications.

The distributor computer 108 may receive information about pricing information from the manufacturer, inventory of the manufacturer and/or dealer, customer feedback, work orders, contracts, warrantee/product registrations, invoices, and credit applications.

The dealer computer 112 may receive information for customer presentations such as the histories of the manufacturer and/or distributor, pricing information for each product, specifications for each product that describe the product features, videos and photos of the product(s), explanations of the technologies used in the product(s), awards won by the manufacturer and/or distributor, results of customer satisfaction surveys for the manufacturer and/or distributor, customer testimonials about the manufacturer and/or distributor, product inventories of the manufacturer and/or distributors, delivery/manufacturing time for a particular product, a template contract, and a warrantee/product information.

The sales person computer 116 may receive to use in a customer presentation such as the histories of the manufacturer, distributor, and/or dealer, pricing information for each product, specifications for each product that describe the product features, videos and photos of the product(s), explanations of the technologies used in the product(s), awards won by the manufacturer, distributor, and/or dealer, results of customer satisfaction surveys for the manufacturer, distributor, and/or dealer, customer testimonials about the manufacturer, distributor, and/or dealer, product inventories of the manufacturer, distributor, and/or dealer, delivery/manufacturing time for a particular product, a template contract, and a warrantee/product information.

The sales person's computer 116 may also receive the information 101 from the storage system 102. The sales person's computer 116 may then use that information in sales presentations to customers. The information 101 may include sales information related to each of the entities involved in selling a product such as the manufacturer, distributor, and/or dealer. The information 101 may include a testimonial, an award, a recognition, a benefit, a history, or any other relevant information about the entities involved in selling the product to assure the customer about the quality of the HVAC system and services that the customer may purchase from these entities.

The computers 104, 108, 112, 116 may communicate with the storage system 102 over a network such as the Internet, or over any other suitable combination of networks such as mobile networks or local area networks.

The storage system 102 includes a server that may host a web site, a web application, web portal, web interface, database, and/or the like that allows the various computers 104, 108, 112, 116 to input the information 106, 110, 114, 118 into the storage system 102. The storage system 102 preferably restricts access to manufacturers, distributors, dealers, sales representatives, and/or customers who have been authorized to provide or receive information to the system 102. The storage system 102 generally collects all inputted information and synchronizes it for data storage, reporting, analytics, and for use in sales presentations. For example, the storage system 102 may provide reports (which may include information for sales presentations) and/or analytics 122 relating to the information to a computer 120, which may be any of the computers 104, 108, 112, 116, or another computer. Some examples of the information 118 that the storage system 102 may store from the computer 116 includes sales information about the manufacturer, distributor, and/or dealer, navigation information for products shown on a mobile computing device such as a tablet computer, and customer data from the mobile computing device, among others.

The system 100 is illustrated as an exemplary schematic diagram of relationships. Particular embodiments of the system 100 may utilize various computers instead of or in addition to computers in other configurations, and data may be stored in various storage systems instead of or in addition to storage system and/or generated in real time during operations of the system 100. The computers may be any type of computer including but not limited to, a desktop computer, a laptop computer, a personal digital assistant (PDA), smartphone, cell phone, or tablet computer. The computers may also include distributed computer systems and sub-networks which comprise, one or more computers, terminals, servers, gateways or other system components located at the physical facilities of or remote from but under the control of a given class of user. The storage system 102 may be any type of server or database management system and may also be a computer as described above.

FIG. 2 is a schematic diagram of a computer 200. The computer 200 may be any of the computers 104,108, 112, 116 as well as the storage system 102 shown in FIG. 1. Computer 200 includes a processing device 202, an input/output device 204, memory 206, and operating logic 208. Furthermore, computer 200 communicates with one or more external devices 210.

The input/output device 204 allows the computer 200 to communicate with the external device 210. For example, the input/output device may be a network adapter, network card, or a port (e.g., a USB port, serial port, parallel port, VGA, DVI, HDMI, FireWire, CAT 5, or any other type of port). The input/output device 204 may be comprised of hardware, software, and/or firmware. It is contemplated that the input/output device 204 includes more than one of these adapters, cards, or ports.

The external device 210 may be any type of device that allows data to be inputted or outputted from the computer 200. For example, the external device 210 may be another computer, a server, a printer, a display, an alarm, an illuminated indicator, a keyboard, a mouse, or a touch screen display. Furthermore, it is contemplated that the external device 210 may be integrated into the computer 200. For example, the computer 200 may be a smartphone, a laptop computer, or a tablet computer in which case the display would be an external device 210, but the display is integrated with the computer 200 as one unit, which consistent with the general design of smartphones, laptop computers, tablet computers, and the like. It is further contemplated that there may be more than one external device in communication with the computer 200. The computer 120 is one example of an external device 210.

Processing device 202 can be of a programmable type, a dedicated, hardwired state machine, or a combination of these; and can further include multiple processors, Arithmetic-Logic Units (ALUs), Central Processing Units (CPUs), or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a combination of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

FIG. 2A is a schematic block diagram of processing subsystem 220 for collecting, calculating, and presenting information during a sales presentation. The processing subsystem 220 includes a processing device 202 that may be part of a computer 200 such as a mobile computing device 116. The processing device 202 includes modules configured to provide multiple functionalities relating to mobile computing devices. The exemplary embodiments described herein may include a number of modules providing a number of functionalities. A module may be implemented in operating logic 208 as operations by software, hardware, artificial intelligence, fuzzy logic, or any combination thereof, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or in part with other modules or devices. The operations of any module may be performed wholly or partially in hardware/software or by other modules. The presented organization of the modules is exemplary only, and other organizations, configurations and arrangements are contemplated.

The processing subsystem 220 preferably includes an input/output module 222 to receive and/or transmit information from the mobile computing device 116. The processing subsystem 220 further includes a client information module 224 for receiving information about a client or customer such as name, address, contact information, etc.

The processing subsystem 220 preferably includes a customer preferences module 226 for receiving information about comfort and aesthetic preferences for a customer such as sound, energy savings, clean air, and hot spots. The customer preferences module 226 may receive such information through a comfort checklist interface which prompts for input regarding preferences for a variety of comfort or aesthetic preferences. For example, a particular customer may prefer an HVAC system that is quiet in which case they can select that the volume of sound produced by the HVAC system is an important criteria in their purchasing decision. A customer can make a similar selection for other comfort preferences such as energy savings (e.g., lower monthly energy bill because of the efficiency of the HVAC equipment purchased), clean air (e.g., the degree to which the HVAC equipment kills germs and other microbes), hot spots (e.g., increasing the number of vents or performing special design of the HVAC system to reduce areas in a room that is either too hot or too cold), humidity (e.g., how well the system controls humidity), connectivity (e.g., whether the components can controlled electronically or remotely), warranty (e.g., whether a strong warranty accompanies the particular component), and performance (e.g., the quality of the component).

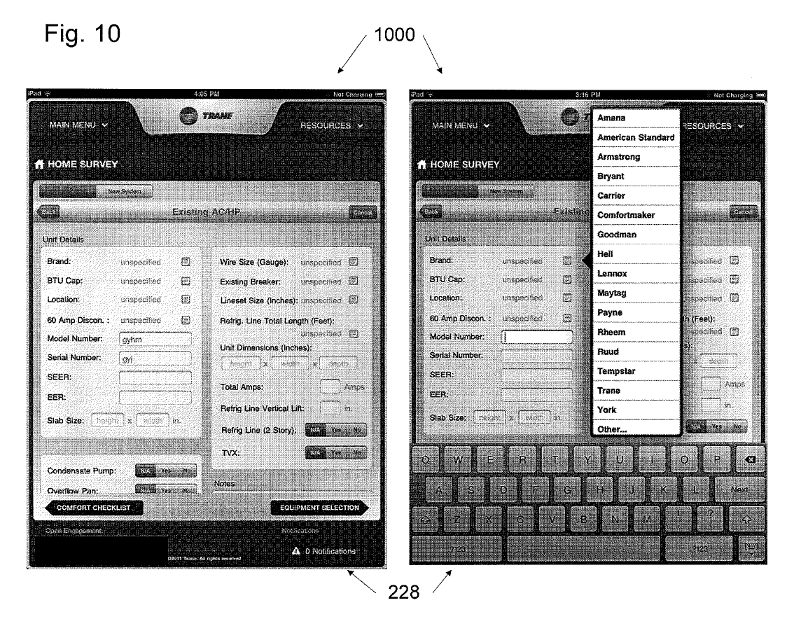

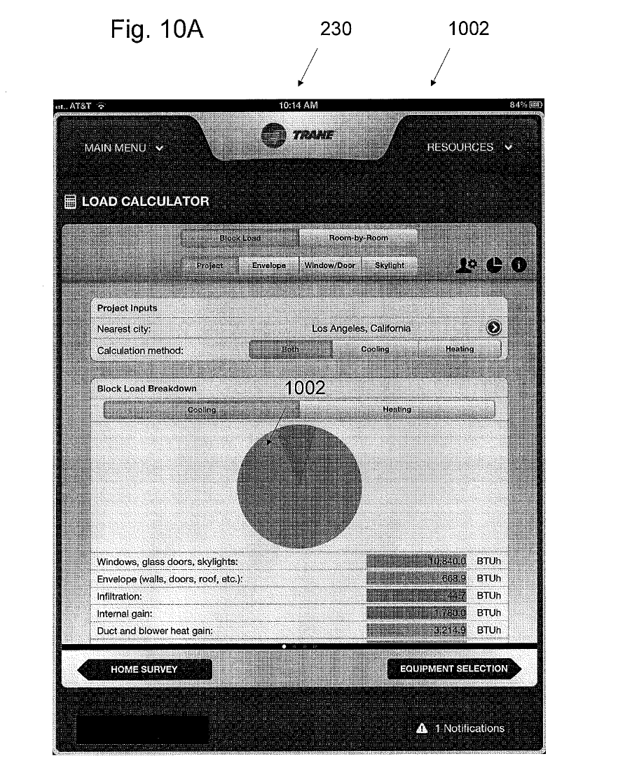

The processing subsystem 220 may include a home survey module 228 for receiving information about the building such as the number rooms, number of windows, number of doors, framing, square-footage, existing ductwork, existing equipment, electrical equipment, etc. FIG. 10 illustrates an example of the type of information that may be collected by the home survey module 228. This information may also be stored with the customer criteria 232.

The processing subsystem 220 may include a load calculation module 230 that calculates load information for an HVAC system based on the customer criteria 232. The customer criteria may include items from the customer preferences module 226 such as sound, energy savings, clean air, hot spots, humidity, connectivity, warranty, and performance as well as items from the home survey module 228 such as the number rooms, number of windows, number of doors, framing, square-footage, existing ductwork, existing equipment, electrical equipment, etc, and may also include information from the client information module 224 such as location or region.

The customer criteria 232 may be stored on the mobile computing device 116 and may also be transmitted and stored on the storage system 102. It is contemplated that any or a combination of the computers 102, 104, 108, 112, 116, 120 may calculate the load(s).

The processing subsystem 220 may include an equipment selection module 234 that presents the customer with various components (e.g., an outdoor unit, a furnace, a heat pump, etc.) that may be used in a HVAC system. The equipment selection module 234 allows the customer to select particular components to create their personalized HVAC system. The components presented to the customer are determined by the equipment selection module 234 based on the calculated load, the customer criteria, and/or any other relevant data. The components presented to the customer for selection are ones that meet certain certification standards, for example, the standards set forth by the Air-Conditioning, Heating, and Refrigeration Institute (AHRI). These standards ensure that when all of the various HVAC components are put together in an HVAC system, the efficiency, performance, and rating of the components is maintained. The equipment selection module 234 ensures that the combination of components in a HVAC system meet one or more predetermined standards or certification criteria. It is contemplated that any or a combination of the computers 102, 104, 108, 112, 116, 120 may determine the equipment to be presented or determine that the equipment meets the predetermined standards.

The processing subsystem 220 may also include a presentation module 236 for presenting sales information 238 to the customer. For example, the sales information may include information 238 about the entities involved in the sale of the HVAC components or an HVAC system to the customer. The entities may include the manufacturer, distributor, and/or dealer of the HVAC components and/or HVAC system. The sales information 238 may include an identity or brand, a testimonial, an award, a recognition, a benefit, and/or a history of one or more of the entities. The sales information 238 may be in the form of text, a video, and/or a picture. The sales information explains to the customer why the customer should choose the particular manufacturer, distributor, and/or dealer.

The processing subsystem 220 may also include a proposal module 240 to present one or more proposal documents 242 such as a proposal, a work order, a contract, a warrantee/product registration, an invoice, and a credit application to a customer during a sales presentation. The customer may review and sign any or all of the proposal documents 242 on the mobile computing device 116. The proposal documents 242 may be stored on the mobile computing device 116. The mobile computing device 116 may transmit the proposal documents 242, signed or unsigned, to any of the other computers 102, 104, 108, 112, 116, 120.

FIG. 2B is a schematic block diagram of processing subsystem 250 for receiving, transmitting, and maintaining information for HVAC systems. The processing subsystem 250 may be part of storage system 102, which includes a server. The processing subsystem 250 includes an input/output module 252 that allows the storage system to communicate with other devices and/or users.

The processing subsystem 250 may also include a web interface module 254 that is in communication with the input/output module 252 to transmit and receive or host information over a network. For example, any of the computers 104, 108, 112, 116, 120 may use the web interface module 254 to store and/or retrieve information from the database 256. The database 256 may store any type of information including customer criteria 232, sales information 238, and/or proposal documents 242.

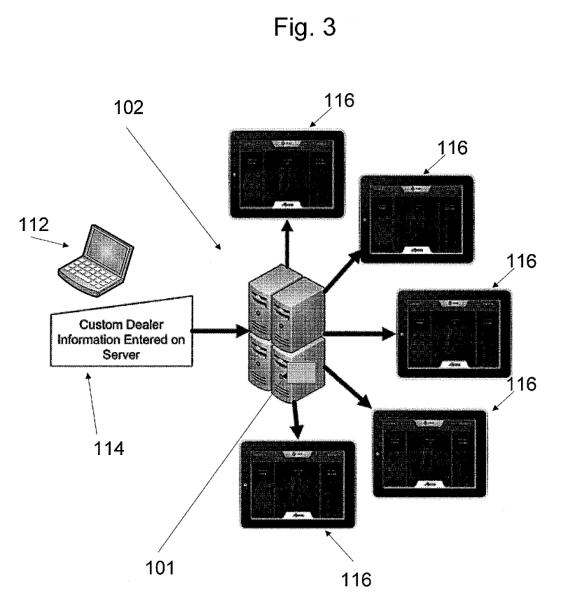

FIG. 3 illustrates another aspect of the system 100. A dealer computer 112 may make changes to their information 114, such as their pricing or sales presentation information, remotely in a web interface or web portal where the dealer can Create Once, Publish Everywhere (COPE). Moreover, once the information 101 is updated, it may be automatically transmitted to the computers 116 for use in client presentations.

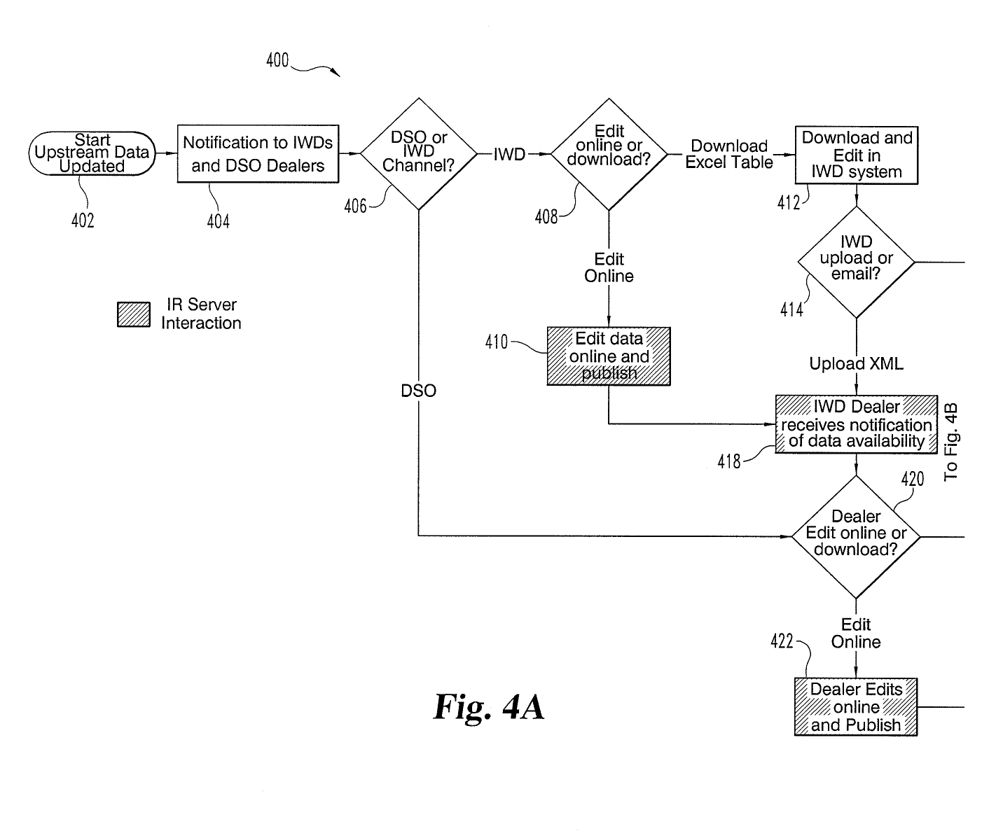

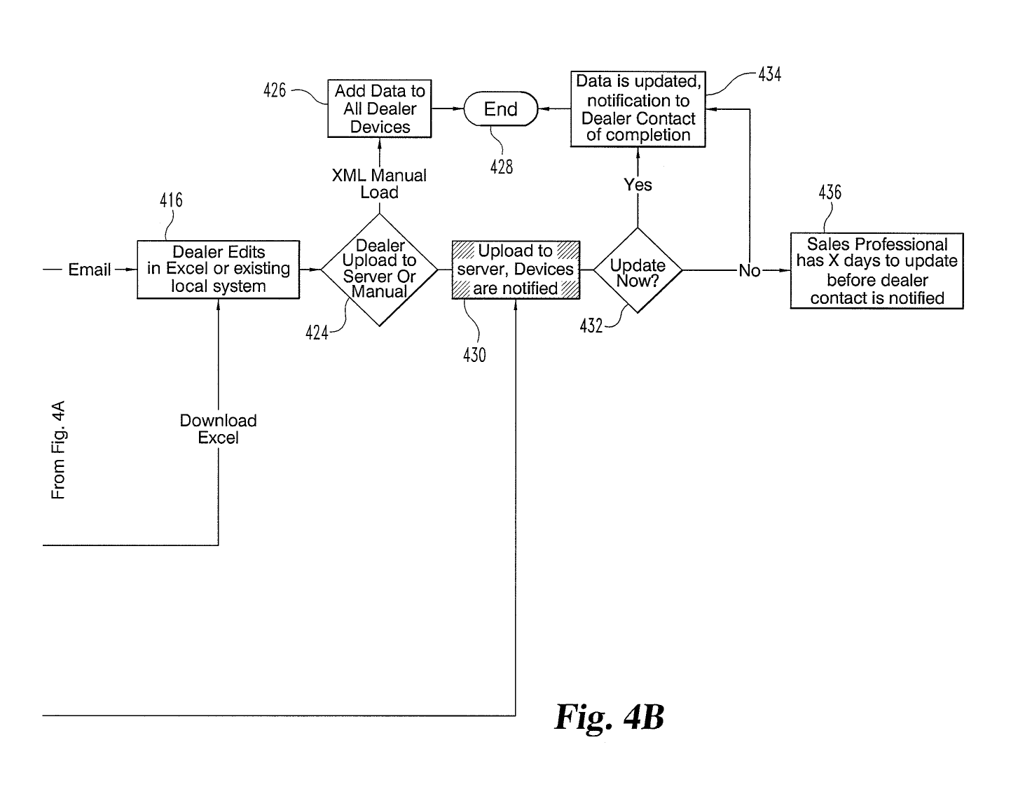

FIG. 4 is a schematic flow diagram 400 of a technique for downloading information and data to an application, and in particular pricing information. Operations illustrated are understood to be examples only, and operations may be combined or divided, and added or removed, as well as re-ordered in whole or in part, unless explicitly stated to the contrary.

Generally, pricing data is established and/or updated by the manufacturer and a notification goes to channel partners. That information is stored and the channel partner can layer on additional data or modify the data and publish to the dealership. The dealer may view the data that is stored and layer modified data that will be published to the sales professional for presentation.

There are generally two distributions paths for an HVAC product. One is from a manufacturer to a distribution sales office (DSO), which is owned by the manufacturer. The second distribution path is from a manufacturer to a independent warehouse distributor (IWD) that is not owned by the manufacturer. Generally, in either case, a dealer updates its pricing data based on the edits by either the DSO or the IWD.

The technique 400 in FIG. 4 shows a method for establishing or updating pricing information for the two distribution paths including how and at-what times the DSO and IWD adjust the manufacturer's prices and provide that pricing to a dealer for adjustment. Moreover, the pricing data in FIG. 4 may be stored in the storage system 102 and distributed to the mobile computing devices 116. Furthermore, the pricing information edited and updated by the manufacturer, distributor, and dealer may be layered and stored in the storage system 102 in such a way that it is apparent how much the price adjustment is for each entity.

Boxes that are shaded indicate a step that may occur at the storage system 102. In operation 402 pricing data is established or updated in the storage system 102 by a manufacturer. In operation 404, a notification is sent to the DSOs and IWDs notifying them of the update. In operation 406, a decision is made whether it is DSO or IWD. If it is a IWD, the IWD may edit the pricing information online or download the pricing information in operation 408. The IWD can choose to edit the information online and publish the updated information in operation 410 or download in Excel, for example, and edit in a IWD system as in operation 412. If the IWD edits in the IWD system, it is then determined whether to upload or email the updated pricing in operation 414. If the IWD emails the changes, it is sent to a dealer for updating in operation 416. If the IWD edits the pricing information online, the pricing information is uploaded to the storage system 102. The technique 400 then proceeds to operation 418 in which a notification is sent to a IWD dealer that the uploaded pricing information is available for updating by the dealer.

In operation 420, the dealer decides whether to edit the pricing information online or locally. If the dealer chooses to edit the pricing information online, the dealer edits the pricing information in the storage system 102 and publishes the updated pricing information. If the dealer decides to edit the pricing information locally, the dealer downloads the pricing information in, e.g., Excel and then decides whether to edit in Excel or a local system in operation 416. In operation 424, the dealer then decides whether to upload to the storage system 102 or update the pricing information manually. In operation 426, the dealer updates all of the dealer's mobile computing devices 116 manually by transmitting an XML pricing update to the mobile computing devices 116. The technique 400 then ends 428 for this path.

In operation 430, if the dealer chooses to upload the updated pricing information to the storage system 102 in XML. Then, the mobile computing devices 116 are notified of the update. In operation 432, the mobile computing device 116 can receive the update immediately as in operation 434 in which case a notification is sent to the dealer contact notifying them that the mobile computing device 116 has been updated. If the mobile computing device 116 is not updated immediately, in operation 434 the device has X number of days to receive the updated pricing information before a dealer contact is contacted. Any of the entities may set the value for X. It is contemplated that the notifications may be sent by an email, a text message, an alert, a reminder, a calendar entry, or by any other means known to those of skill in the art.

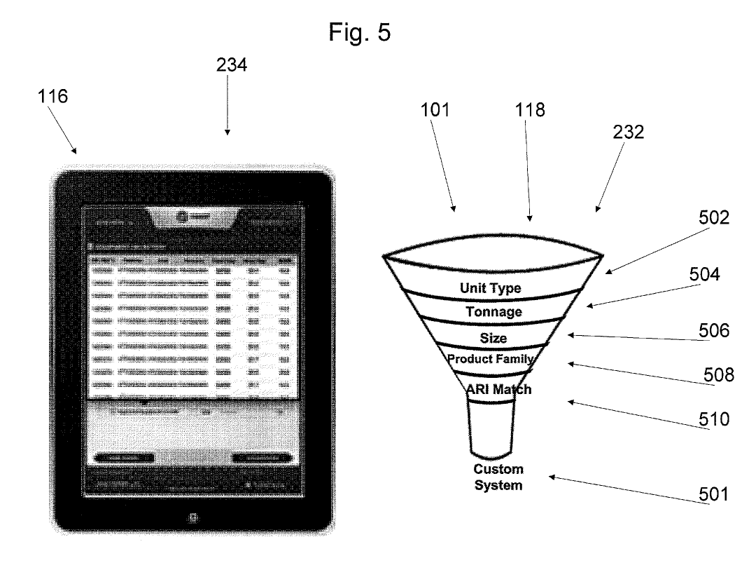

FIG. 5 illustrates information 101 that may be used to recommend options for a custom system or product 501 for a customer. For example, the storage system and/or any of the computers 104, 108, 112, 116, 120 may enable dealers to collect detailed information related to the current status of the dwelling/location that can be used to customize the recommended systems or work for a client. For example, the storage system and/or any of the computers 104, 108, 112, 116, 120 may use one or more of the following pieces of information 101 and/or customer criteria 232 to recommend the custom system 501: unit type 502, tonnage 504, size 506, product family 508, and/or ARI Match 510. Moreover, the computer 116 may automatically recommend an approved system 501 based on size of unit, tonnage, and matching appliances. The approved system 501 may be approved by a standard setting entity, for example, AHRI or another standard entity. It is contemplated that more than one custom system or product 501 may be identified such that the each product is at a different level such as best, better, good or top-down. Moreover, the system in FIG. 5 may be implemented by the equipment selection module 234.

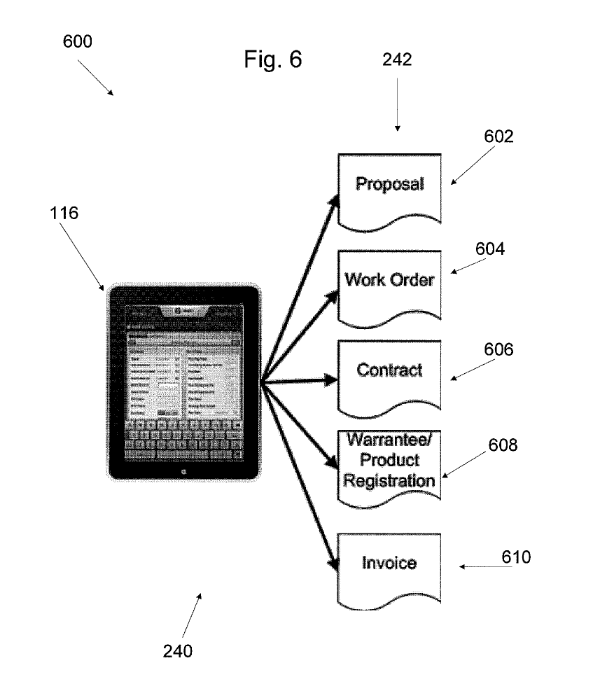

FIG. 6 illustrates another aspect of the system 100 in which the process of creating a one or more proposal documents 242 including proposal 602, a work order 604, contract 606, warrantee/product registration 608, credit applications, and/or an invoice 610 may be automated by the computer 116 using the information 101 and 118 and a proposal module 240.

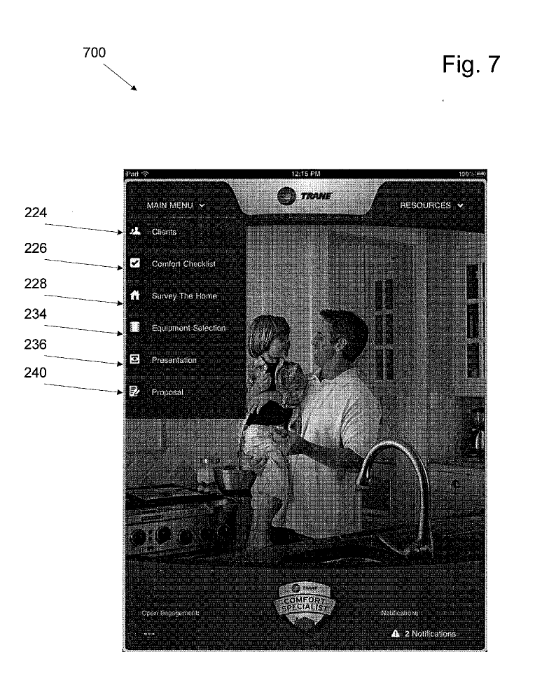

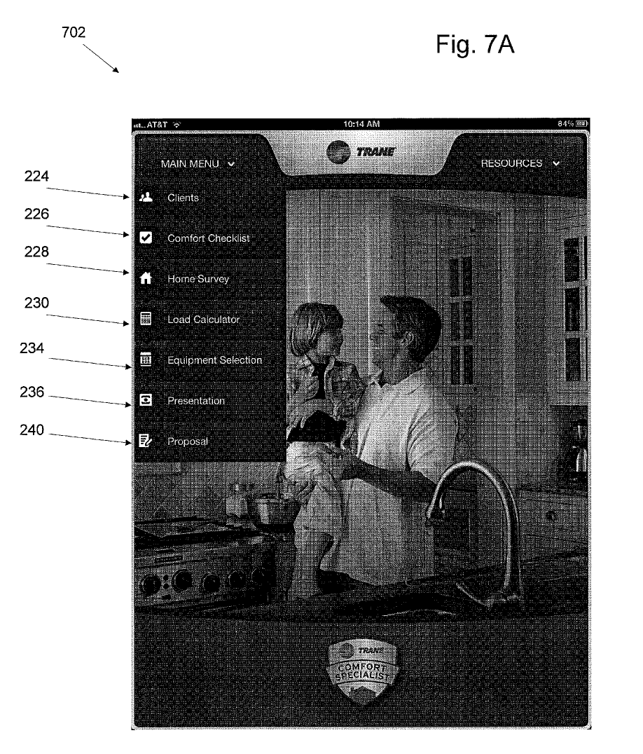

FIG. 7 illustrates a main menu feature 700 of the mobile computing device 116 displaying a main menu including various links such as “Clients,” “Comfort Checklist,” “Survey the Home,” “Equipment Selection,” “Presentation,” and “Proposal.” Moreover, each of these links corresponds to a module included on the mobile computing device 116 such as the client information module 224, the customer preferences module 226, the home survey module 228, the equipment selection module 234, the presentation module 236, and the proposal module 240.

FIG. 7A illustrates another embodiment of a main menu feature 702 of the mobile computing device 116 displaying a main menu including various links such as “Clients,” “Comfort Checklist,” “Survey the Home,” “Load Calculator,” “Equipment Selection,” “Presentation,” and “Proposal.” Moreover, each of these links corresponds to a module included on the mobile computing device 116 such as the client information module 224, the customer preferences module 226, the home survey module 228, the load calculation module 230, the equipment selection module 234, the presentation module 236, and the proposal module 240.

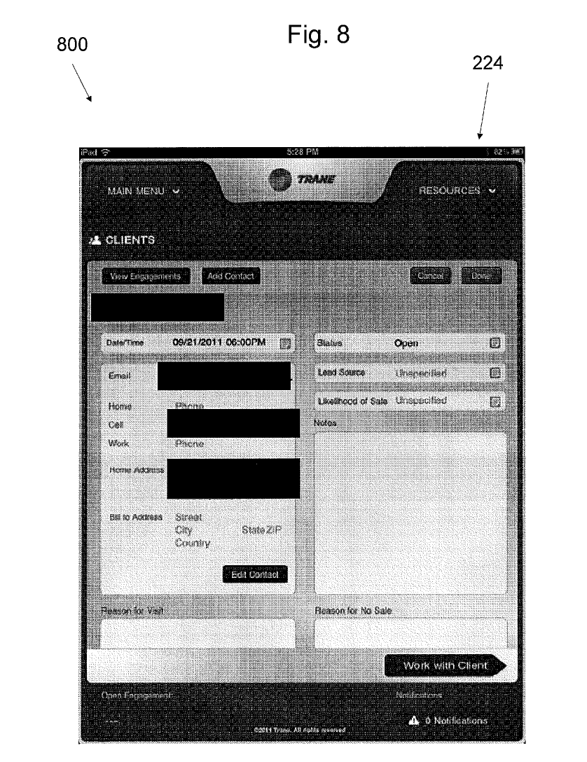

FIG. 8 illustrates a clients feature 800 of the mobile computing device 116 that allows various client information to be inputted and displayed as well as adding contacts and scheduling appointments. Contact information for a client is represented by black boxes in the embodiments illustrated, though it shall be appreciated that alpha-numeric information specific to a customer is provided in practice. The feature 800 may be implemented using the client information module 224.

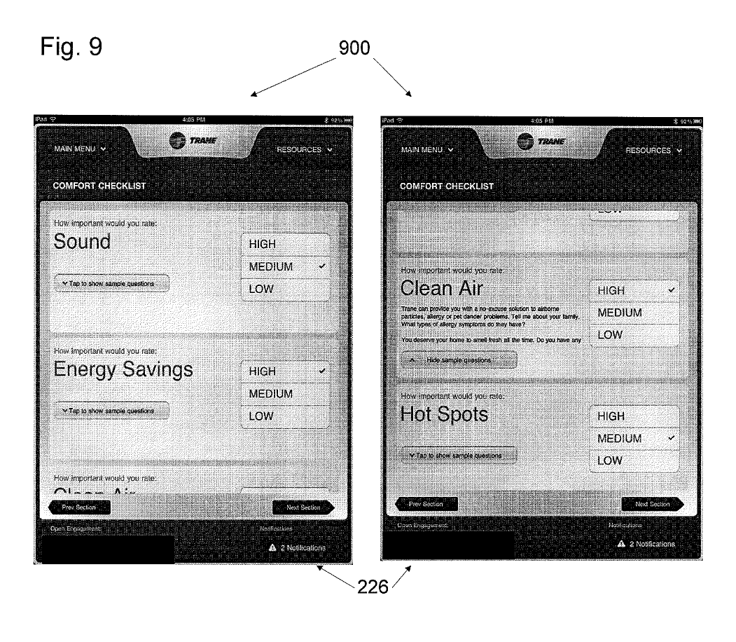

FIG. 9 illustrates multiple features 900 of the mobile computing device 116 for a customer preferences in which a client may select the comfort attributes that the client wants in their custom system 501. The feature 900 may be implemented using the customer preferences module 226. In addition, the comfort attributes may include sound, energy savings, clean air, hot spots, humidity, connectivity, warranty, and performance.

FIG. 10 illustrates multiple features 1000 of the mobile computing device 116 for a home survey. The home survey obtains information such as the number rooms, number of windows, number of doors, framing, square-footage, existing ductwork, existing equipment, electrical equipment, etc. that may be used to specify equipment such as a custom system 501. The features 1000 may be implemented using the home survey module 228.

FIG. 10A illustrates a features 1002 of the mobile computing device 116 for calculating a load for an HVAC system based on the customer criteria 232 and/or information from the client information module 224. The calculated load may be used to specify equipment such as a custom system 501. The feature 1002 may be implemented using the home survey module 230.

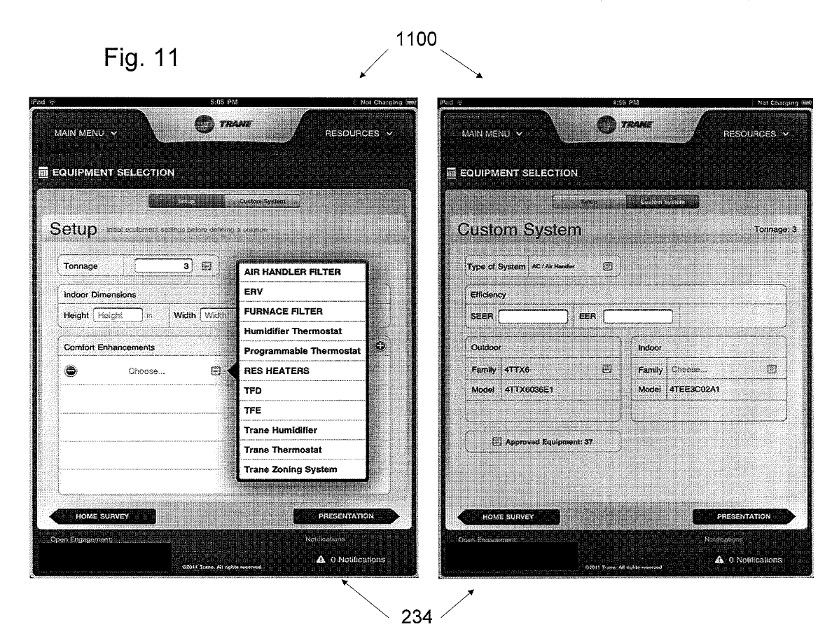

FIG. 11 illustrates multiple features 1100 of the computer 116 for obtaining or displaying information relating to equipment selection including determining the list of equipment for selection. The features 1100 may be implemented using an equipment selection module 234.

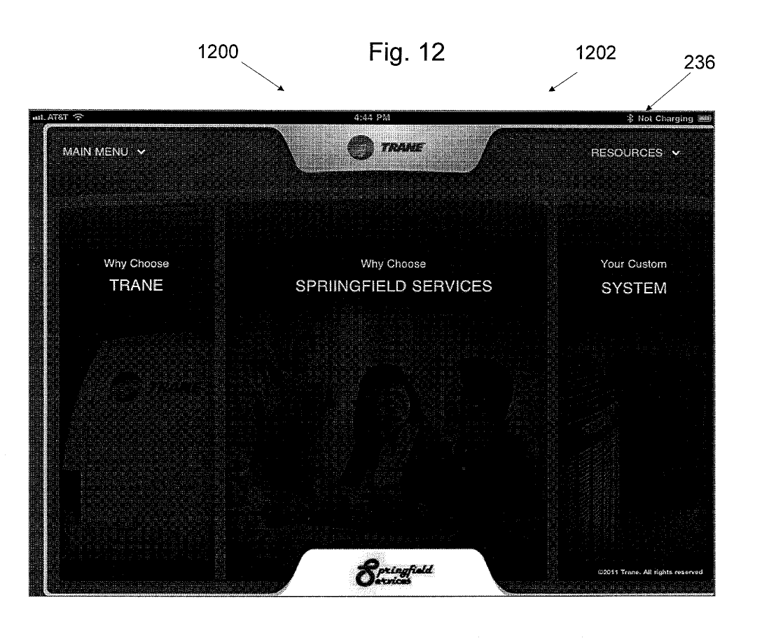

FIG. 12 illustrates a feature 1200 of a presentation 1202 on a mobile computing device 116 relating to the custom system 501 for a client. Moreover, information displayed here may be a result of the process to obtain information from the manufacturer and/or channel partners. The feature 1200 and presentation 1202 may be implemented using the presentation module 236.

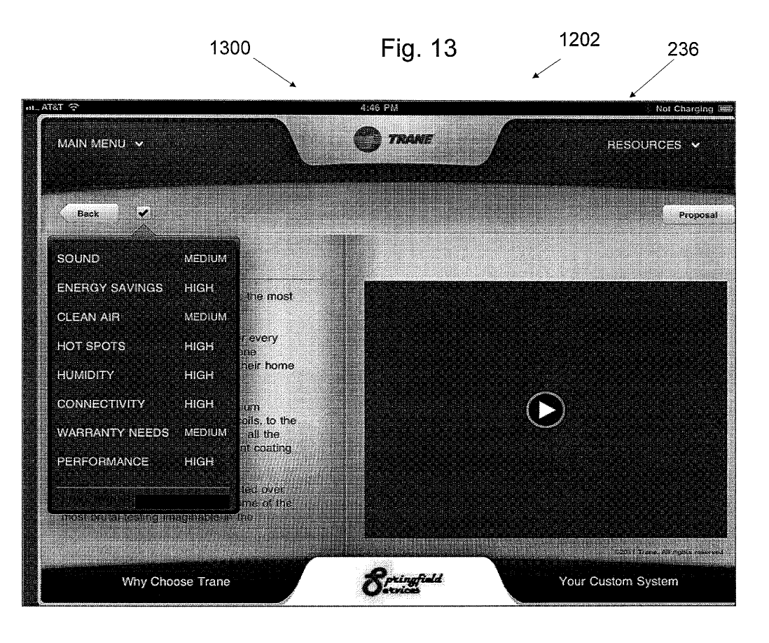

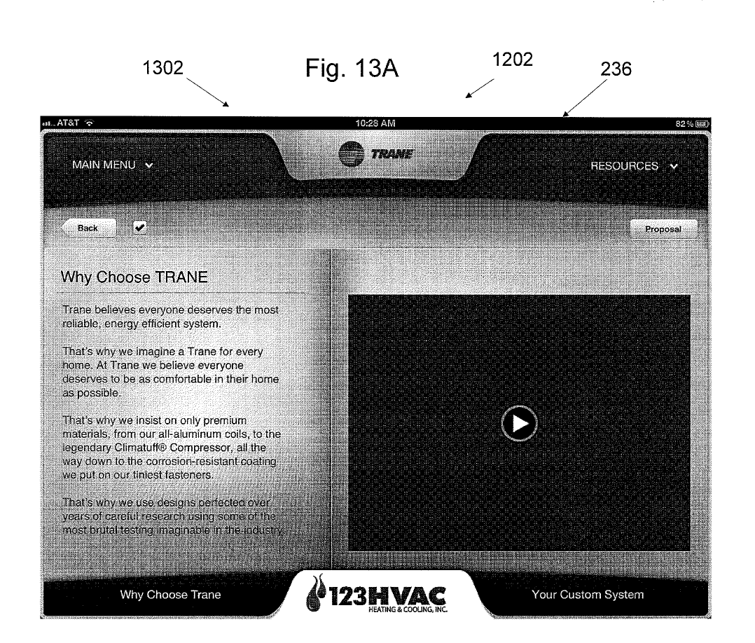

FIG. 13 illustrates a feature 1300 of the mobile computing device 116 of why the client should choose a particular manufacturer. The feature illustrates information 101 about the manufacturer including text and a video. The feature 1300 and presentation 1202 may be implemented using the presentation module 236.

FIG. 13A illustrates a feature 1302 of the mobile computing device 116 of why the client should choose a particular manufacturer. The feature illustrates information 101 about the manufacturer including text and a video. The feature 1302 and presentation 1202 may be implemented using the presentation module 236.

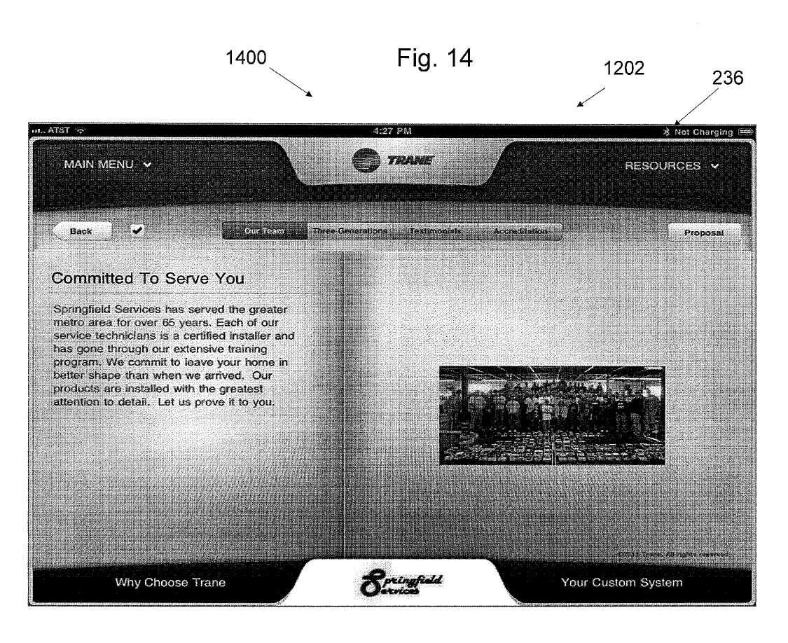

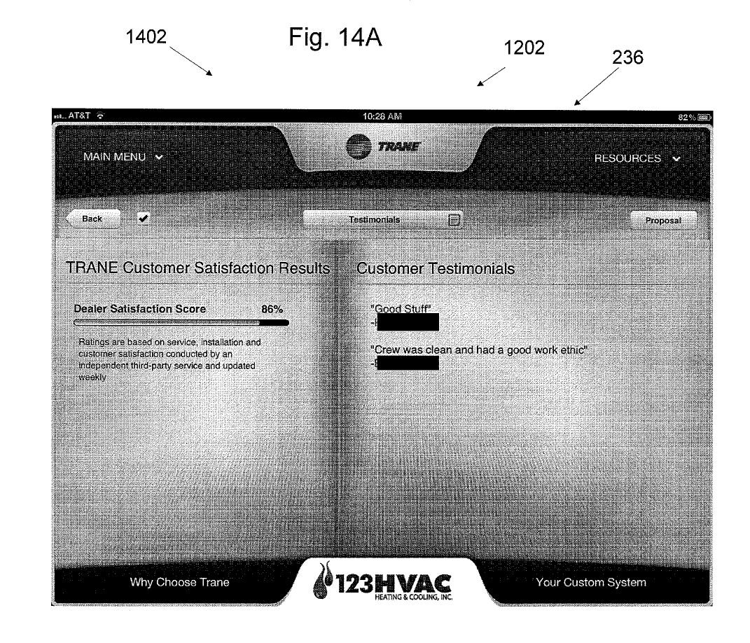

FIG. 14 illustrates a feature 1400 of the mobile computing device 116 of why the client should choose a particular distributor or dealer. Moreover, the information 101 displayed here may be a result of the process to obtain information from the manufacturer and/or channel partners that is stored in storage system 102. The feature 1400 may be implemented using the presentation module 236.

FIG. 14A illustrates a feature 1402 of the mobile computing device 116 showing a satisfaction score and testimonials for a manufacturer. Moreover, the information 101 displayed here may be a result of the process to obtain information from the manufacturer and/or channel partners that is stored in storage system 102. The feature 1402 may be implemented using the presentation module 236.

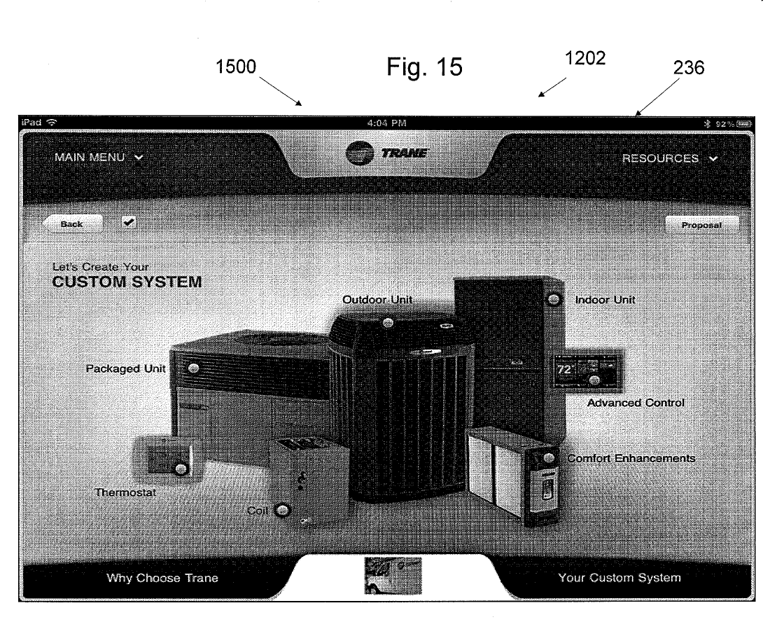

FIG. 15 illustrates a feature 1500 of the mobile computing device 116 in which the custom system 501 is displayed to the client. Moreover, information displayed here may be a result of the process to obtain information from the manufacturer and/or channel partners and the equipment selection feature 1100 and the equipment selection module 234. In addition, each of the components presented includes a dot on them which can be selected by a user of the mobile computing device 116 to display detailed product information for each of the components. The feature 1500 may be implemented using the presentation module 236.

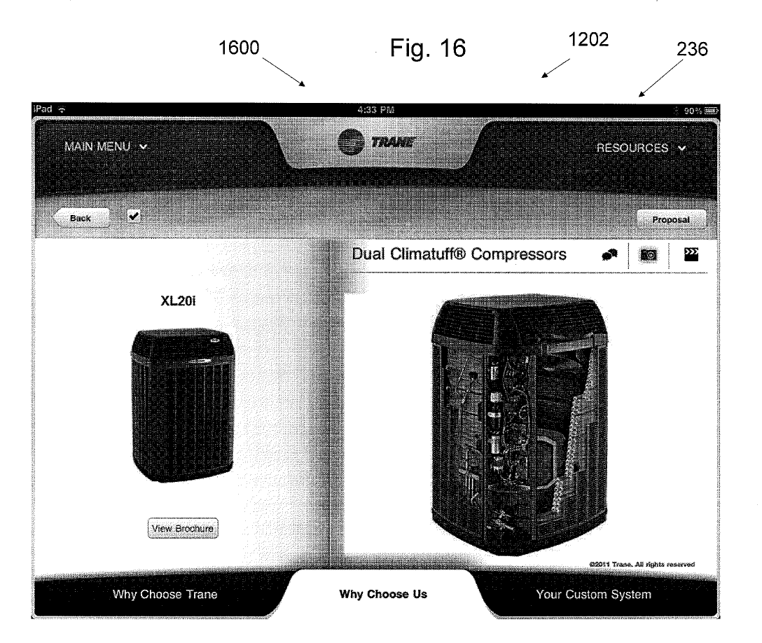

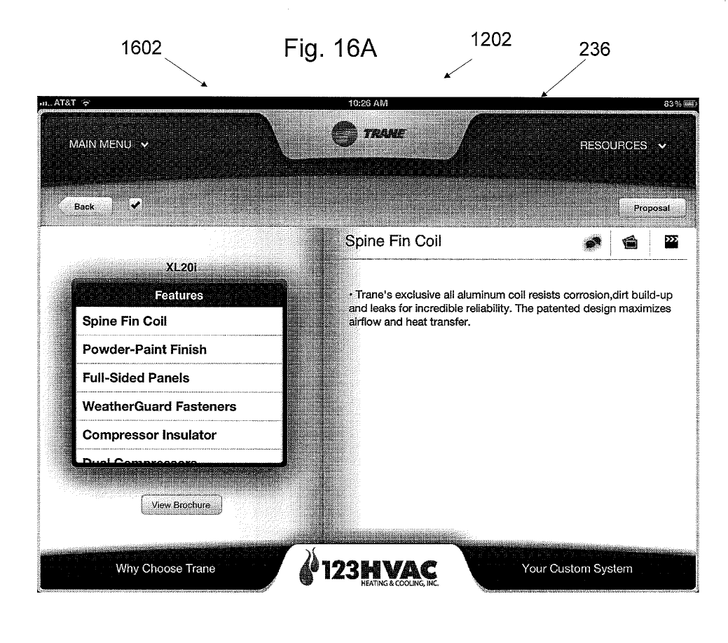

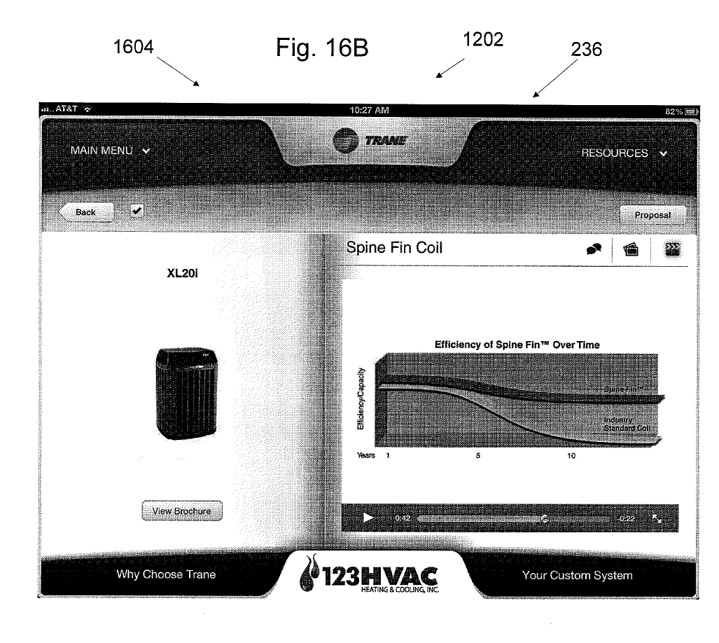

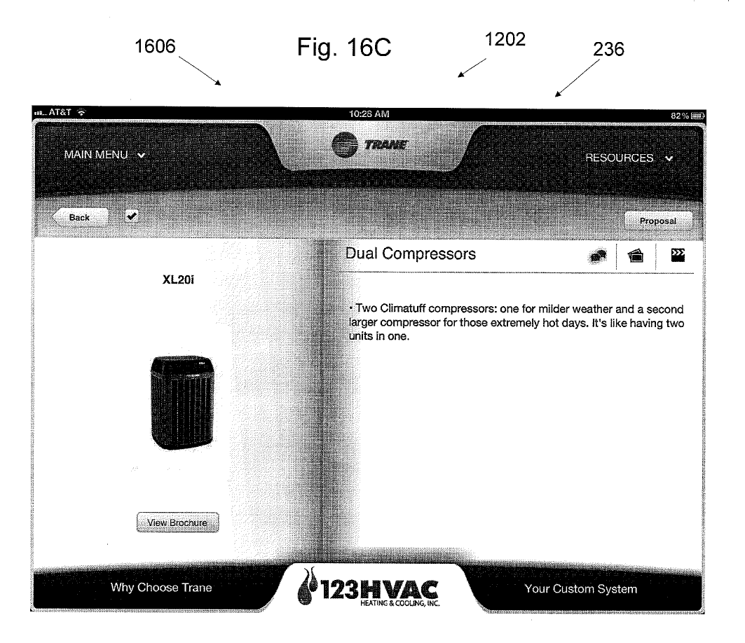

FIG. 16 illustrates another feature 1600 of the mobile computing device 116 in which detailed product information for particular components of the custom system 501 are displayed to the client in response to a user selecting a component as seen in FIG. 15. Moreover, information displayed here may be a result of the process to obtain information from the manufacturer and/or channel partners and the equipment selection feature 1100. The feature 1600 may be implemented using the presentation module 236.

FIG. 16A illustrates another feature 1602 of the mobile computing device 116 in which detailed product information for particular components of the custom system 501 are displayed to the client in response to a user selecting a component as seen in FIG. 15. Moreover, information displayed here may be a result of the process to obtain information from the manufacturer and/or channel partners and the equipment selection feature 1100. In addition, in feature 1602, a user can select specific features to view information about or the user can select a brochure to view. The feature 1602 may be implemented using the presentation module 236.

FIG. 16B illustrates another feature 1604 of the mobile computing device 116 in which detailed product information for particular components of the custom system 501 are displayed to the client in response to a user selecting a component as seen in FIG. 15. Moreover, information displayed here may be a result of the process to obtain information from the manufacturer and/or channel partners and the equipment selection feature 1100. In addition, in feature 1604, a video about a specific feature (spine fin coil) that was selected in feature 1602 is being shown. The feature 1604 may be implemented using the presentation module 236.

FIG. 16C illustrates another feature 1606 of the mobile computing device 116 in which detailed product information for particular components of the custom system 501 are displayed to the client in response to a user selecting a component as seen in FIG. 15. Moreover, information displayed here may be a result of the process to obtain information from the manufacturer and/or channel partners and the equipment selection feature 1100. The feature 1606 may be implemented using the presentation module 236.

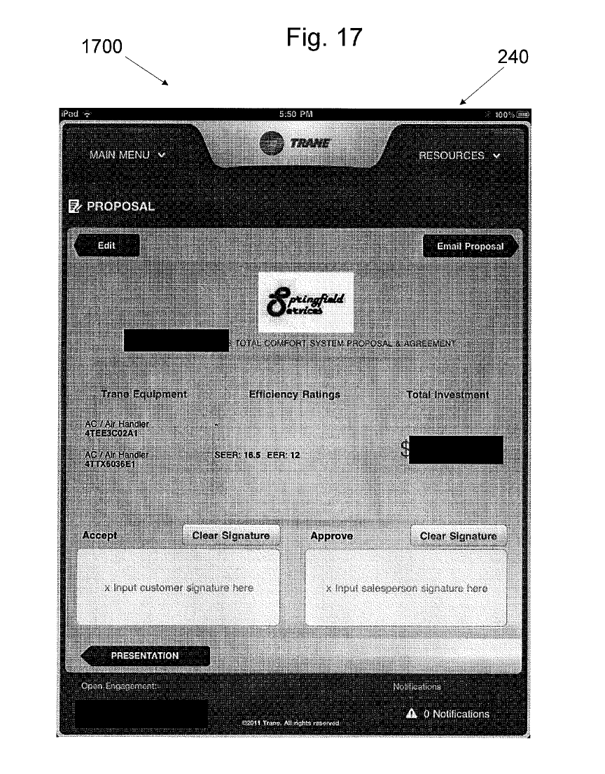

FIG. 17 illustrates a feature 1700 of the mobile computing device 116 in which a proposal is provided to the client including the price of the custom system 501 and signature blocks for proceeding with the sale. Various proposal documents 242 may be presented to the client by feature 1700. The feature 1700 may be implemented using the proposal module 240.

It is contemplated that the look and the number features 700, 702, 800, 900, 1000, 1002, 1100, 1200, 1300, 1302, 1400, 1402, 1500, 1600, 1602, 1604, 1606, and 1700 may be modified as necessary depending on the application and information to be obtained and/or displayed.

The computer 116 may determine a custom system 501 and make a presentation 1202, among other things, without having a network connection. Moreover, the computer 116 may perform these actions without the storage system 102.

The present application may be implemented on any type of computer and using a variety of different software and/or hardware. For example, the present application may be implemented using Microsoft Excel, Microsoft Access, Microsoft SQL Server, any of Oracle's database systems, MySQL, custom software modules, custom databases, any other appropriate software or database, or any combination thereof. When the computer or storage system is configured as a database, it is contemplated that the database may be any type of database, such as relational, hierarchical, object-oriented, and/or the like.

A computer readable medium may refer to any tangible storage and/or transmission medium that participate in providing instructions to a processing device for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium.

One aspect of the present application includes a system, comprising: a server including a web interface and a database; a plurality of computers configured to transmit information to the server through the web interface, wherein the server is structured to store the information in the database; and an external device to display a report generated by the server based on the information.

Other features of the aspect of the present application may include: wherein the computers includes at least one manufacturer computer, a distributer computer, a dealer computer, and sales person computer; wherein the information includes at least one unit type, tonnage, size, product family, matching appliances, and ARI match; wherein one of the computers is structured to recommend a custom product; wherein one of the computers is structured to automatically recommend a custom product; wherein one of the computers is structured to automatically generate at least one of a proposal, a work order, a contract, a warrantee/product registration, an invoice, and a credit application; wherein one of the computers is structured to display a presentation; wherein the one of the computers is disconnected to the server; wherein the one of the computers is a tablet computer; wherein the product information relates to an HVAC device.

Another aspect of the present application includes a method, comprising: receiving information at a storage system from a first computer through a web portal; storing the information in a database at the storage system; and transmitting the information to a second computer.

Other features of the aspect of the present application may include: recommending a product, based on the information, to a customer with the second computer; presenting the information to a customer with the second computer; wherein the second computer is disconnected from the storage system.

Yet another aspect of the present application may include an apparatus, comprising: a processing device being structured to execute operating logic to: receive product information from a web server; based on the product information, recommend one or more products to a customer; and create at least one of a proposal, a work order, a contract, a warrantee/product registration, an invoice, and a credit application.

The aspect of the present application may include the following feature: the products are classified into one or more levels, wherein the levels include best, better, good, and top-down.

Another aspect of the present application may include a method, comprising: receiving information at a server from at least one of a manufacturer computer, a distributor computer, and a dealer computer through a web portal; storing and synchronizing the information in a database at the server; and automatically transmitting the information to a plurality of sales computers.

The aspect of the present application may include the following feature: wherein at least one of the sales computers comprises a tablet computer.

Another aspect of the present application includes a system, comprising: a database to store sales information for a component, wherein the sales information comprises information about a plurality of entities involved in selling the component; a server in communication with the database, wherein the server is structured to provide the sales information over a network; and a mobile computing device structured to receive the sales information from the server and to present the sales information to a customer.

The aspect of the present application may include the following features: wherein the component is an HVAC component; wherein the entities include a manufacturer and dealer; wherein the entities include a manufacturer, a distributor, and a dealer; wherein the sales information includes at least one of a testimonial, an award, a recognition, a benefit, and a history of the entities; wherein the mobile computing device is further structured to at least one of a proposal, a work order, a contract, a warrantee/product registration, an invoice, and a credit application.

Yet another aspect of the present application may include a mobile computing device, comprising: a memory including operating logic; a processing device in communication with the memory, wherein the processing device is structured to execute the operating logic to: receive customer criteria; generate a list of a plurality of HVAC components based on the customer criteria; present the list of HVAC components to a customer; and allow the customer to select one or more of the HVAC components, wherein a combination of selected HVAC components in an HVAC system conforms to AHRI standards.

The aspect of the present application may include the following features: wherein the processing device is further structured to execute the operating logic to: present sales information to the customer, wherein the sales information comprises at least one of a testimonial, an award, a recognition, a benefit, and a history about a plurality of entities involved in selling the components; wherein the processing device is further structured to execute the operating logic to: receive the sales information from a server in communication with a database; wherein the customer criteria includes at least one of unit type, tonnage, size, and product family; wherein the customer criteria includes a comfort requirement, wherein the comfort requirement includes at least one of sound, energy savings, clean air, hot spots, humidity, connectivity, warranty, and performance; wherein the processing device is further structured to execute the operating logic to: present to the customer at least one of a proposal, a work order, a contract, a warrantee/product registration, an invoice, and a credit application; wherein the processing device is further structured to execute the operating logic to: calculate a load for the HVAC system based on the customer criteria; wherein the calculated load is used to generate the list of HVAC components.

Another aspect of the present application may include a method, comprising: receiving, at a server, sales information from a plurality of entities involved in selling an HVAC system; storing the sales information in a database in communication with the server; receiving, with a mobile computing device, the sales information over a network; and presenting, with the mobile computing device, the sales information to a customer during a sales presentation.

The aspect of the present application may include the following features: receiving and storing updates of the sales information from the entities; maintaining a history of revisions to the sales information stored in the database; wherein at least one entity is a manufacturer and a second entity is a dealer.

Another aspect of the present application may include a mobile computing device, comprising: an input/output module to receive sales information from a server coupled to a database, the input/output module further structured to receive customer criteria for an HVAC system; a load calculation module to calculate a load for the HVAC system based on the customer criteria; an equipment selection module to generate a list of HVAC components based on the load and to allow a customer to select a combination of HVAC components, wherein the combination of selected HVAC components conforms to AHRI standards; and a presentation module to present the sales information about a first entity and a second entity, wherein the first entity is a manufacturer of at least one of the HVAC components and the second entity is a dealer of at least one of the HVAC components.

The aspect of the present application may include the following features: a proposal module to present at least one of a proposal, a work order, a contract, a warrantee/product registration, an invoice, and a credit application; wherein the customer criteria includes at least one of unit type, tonnage, size, product family, sound, energy savings, clean air, hot spots, humidity, connectivity, warranty, and performance; wherein the sales information includes at least one of a testimonial, an award, a recognition, a benefit, and a history of the entities.

Another aspect of the present application may include a method, comprising: receiving sales information from a server; receiving customer criteria for an HVAC system; generating a list of HVAC components based on the customer criteria; receiving a selected combination of HVAC components, wherein the combination of HVAC components conforms to AHRI standards; and presenting, with a mobile device, the sales information about a first entity and a second entity, wherein the first entity is a manufacturer of at least one of the HVAC components and the second entity is a dealer of at least one of the HVAC components.

The aspect of the present application may include the following features: presenting, with the mobile device, at least one of a proposal, a work order, a contract, a warrantee/product registration, an invoice, and a credit application; wherein the customer criteria includes at least one of unit type, tonnage, size, product family, sound, energy savings, clean air, hot spots, humidity, connectivity, warranty, and performance; wherein the sales information includes at least one of a testimonial, an award, a recognition, a benefit, and a history of the entities.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An interactive HVAC sales system, comprising:
a database including a non-transitory computer readable medium configured to store manufacturer information and distributor/dealer information for a plurality of HVAC components, the manufacturer information including manufacturer product specification information for the plurality of HVAC components, manufacturer pricing information for the plurality of HVAC components, manufacturer warranty information for the plurality of HVAC components, manufacturer sales contract term information for the plurality of HVAC components, and manufacturer product availability date information for the plurality of HVAC components, the distributor/dealer information including distributor/dealer pricing information for the plurality of HVAC components, distributor/dealer warranty information for the plurality of HVAC components, distributor/dealer sales contract term information for the for the plurality of HVAC components, and distributor/dealer product availability date information for the plurality of HVAC components; and
a server in communication with the database, a manufacturer computer, a distributor/dealer computer, and a sales representative computer via one or more networks, the server configured with non-transitory computer executable instructions to update the manufacturer information stored in the database based upon information received from the manufacturer computer and to update the distributor/dealer information stored in the database based upon information received from the distributor/dealer computer;
wherein the server is further configured with non-transitory computer executable instructions to receive customer information from the sales representative computer including objective building structure information and subjective customer preference information, identify a subset of the plurality of HVAC components conforming to the objective and the subjective information based upon at least the manufacturer product specification information, identify one or more saleable combinations of the subset of HVAC components meeting predetermined system certification standards, and output information for each of the saleable combinations to the sales representative computer including customer pricing information based upon the manufacturer pricing information and the distributor/dealer pricing information, customer warranty information based upon the manufacturer warranty information and the distributor/dealer warranty information, customer sales contract information based upon the manufacturer sales contract term information and the distributor/dealer sales contract term information, and customer product availability date information based upon the manufacturer product availability date information and the distributor/dealer product availability date information.

2. An interactive HVAC sales system according to claim 1 wherein the distributor/dealer pricing information is defined as a function of the manufacturer pricing information and the customer pricing information is based upon the distributor/dealer pricing information.

3. An interactive HVAC sales system according to claim 2 wherein the distributor/dealer pricing information is defined as a percentage of the manufacturer pricing information.

4. An interactive HVAC sales system according to claim 1 wherein the distributor/dealer warranty information is defined as a function of the manufacturer warranty information and the customer warranty information includes the manufacturer warranty information and the distributor/dealer warranty information.

5. An interactive HVAC sales system according to claim 4 wherein the manufacturer warranty information comprises a base warranty and the distributor/dealer warranty information comprises an extended warranty.

6. An interactive HVAC sales system according to claim 1 wherein the distributor/dealer sales contract information is based upon the manufacturer sales contract information and the customer sales contract information is based upon the distributor/dealer sales contract information.

7. An interactive HVAC sales system according to claim 6 wherein the distributor/dealer sales contract information includes all terms of the manufacturer sales contract information and additional terms.

8. An interactive HVAC sales system according to claim 1 wherein the distributor/dealer product availability date information includes first date information for components in dealer/distributor inventory and second date information based upon the manufacturer product availability date information for components not in dealer/distributor inventory, and wherein the customer product availability date information is based upon the latest in time of a plurality of first date information for saleable combinations including only components in dealer/distributor inventory and is based upon one of the latest in time of a plurality of first and second date information and the latest in time of a plurality of second date information for saleable combinations including components not in dealer/distributor inventory.

9. An interactive HVAC sales system according to claim 1 wherein the server is configured to limit access to the information stored in the database to authorized manufacturer computers, authorized distributor/dealer computers, and authorized sales representative computers.

10. An interactive HVAC sales system according to claim 9 wherein the server excludes the authorized sales representative computers from accessing at least one of the manufacturer information and the distributor/dealer information directly.

11. A system, comprising:
a database including a non-transitory computer readable medium configured to store manufacturer information and distributor/dealer information for a plurality of HVAC components, the manufacturer information including manufacturer product specification information for the plurality of HVAC components, manufacturer pricing information for the plurality of HVAC components, manufacturer warranty information for the plurality of HVAC components, and manufacturer product availability date information for the plurality of HVAC components, the distributor/dealer information including distributor/dealer pricing information for the plurality of HVAC components, distributor/dealer warranty information for the plurality of HVAC components, and distributor/dealer product availability date information for the plurality of HVAC components;
a server in communication with the database, a manufacturer computer, and a distributor/dealer computer via one or more networks, the server configured with non-transitory computer executable instructions to update the manufacturer information stored in the database based upon information received from the manufacturer computer and to update the distributor/dealer information stored in the database based upon information received from the distributor/dealer computer; and
a mobile computing device in communication with the server, the mobile computing device being configured with non-transitory computer executable instructions to process building structure information and subjective customer preference information input to the mobile computing device by a user, at least a portion of the manufacturer information and distributor/dealer information received from the server, and predetermined HVAC certification standards to identify and display information for one or more saleable combinations including customer pricing information based upon at least one of the manufacturer pricing information and the distributor/dealer pricing information, customer warranty information based upon at least one of the manufacturer warranty information and the distributor/dealer warranty information, and customer product availability date information based upon at least one of the manufacturer product availability date information and the distributor/dealer product availability date information.

12. A system according to claim 11 wherein the server updates the distributor/dealer pricing information stored in the database based upon a change to the manufacturer pricing information stored in the database and transmits updated distributor/dealer pricing information to the mobile computing device.

13. A system according to claim 11 wherein the display information for each of the saleable combinations includes at least one of a video and a photo of at least one HVAC component.

14. A system according to claim 13 wherein the display information for each of the saleable combinations includes videos or photos of a plurality of HVAC component included in the combination.

15. A system according to claim 13 wherein display information for each of the saleable combinations includes information about a commercial history of at least one of the manufacturer and the distributor/dealer.

16. A system according to claim 11 wherein the manufacturer information includes manufacturer sales contract term information for the plurality of HVAC components, the distributor/dealer information includes distributor/dealer sales contract term information for the for the plurality of HVAC components, and the display information for each of the saleable combinations includes at least one of the manufacturer sales contract term information and the distributor/dealer sales contract term information.

17. A system according to claim 11 wherein the server updates distributor/dealer product availability date information stored in the database based upon a change to the manufacturer product availability date information stored in the database.

18. A system according to claim 11 wherein the distributor/dealer product availability date information is derived from the manufacturer product availability date information and the customer product availability date information is derived from the distributor/dealer product availability date information.

19. A system according to claim 11 wherein the server is structured to provide information from the database to the mobile computing device only if the mobile computing device provides an authorization credential to the server.

20. A system according to claim 11 wherein the server is structured to provide different sets of information from the database to a plurality of mobile computing devices based upon a respective identity or credential of each of the mobile computing devices.
